(19) United States
(12) Patent Application Publication
(10) Pub. No.: US 2005/0084584 A1
(43) Pub. Date: Apr. 21, 2005

(54) Cookies comprising emulsified liquid shortening compositions comprising dietary fiber gel, water and lipid

(76) Inventors: Triveni P. Shukla, New Berlin, WI (US); Gregory J. Halpern, Vernon Hills, IL (US)

Correspondence Address: Timothy J. Fullin;Fullin Legal Services LLC, 711 North Milwaukee Avenue, Libertyville, IL, 60048, US

(21) Appl. No.: 10/689,194

(22) Filed: Oct. 20, 2003

(51) Int. Cl. A21D 10/00

(52) U.S. Cl. 426/549

(57) ABSTRACT

According to the present invention, fat and caloric content of cookies can be reduced by the replacement of a portion fat content normally found in cookies with an equal amount of emulsified liquid shortening composition comprising dietary fiber gel, water and lipid. The result is that fat and caloric content of cookies can be manipulated with minimal effect on taste and texture. Furthermore, these emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of cookies, further health benefits can be achieved by replacing a portion of fat with emulsified liquid shortening compositions comprising dietary fiber gel, water and lipid.

### CROSS-REFERENCE TO RELATED APPLICATIONS

Not Applicable.

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to cookies comprising emulsified liquid shortening compositions comprising dietary fiber gel, water and lipid. Recent media attention to the global problem of obesity demonstrates a need for greater availability of foods with low caloric and fat content. This is especially true for foods that typically have high fat and caloric content, such as cookies.

Cookies typically comprise some combination of flour, butter or margarine, and sugar. Other ingredients can vary according to the type of cookie and the recipe followed, but typically, cookies are high in both fat and caloric content.

In recent years, some companies have begun to offer reduced fat cookies. This variety of cookie, however, often involves increased sugar concentrations in order to compensate for the less desirable taste resulting from lower fat concentrations and frequently fails to retain the desirable taste and texture of cookies comprising higher fat contents.

The absence of a means to reduce the fat and caloric content of cookies while still producing a desirably flavored and textured cookie presents an unmet need in today's food industry.

### BRIEF SUMMARY OF THE INVENTION

It is an object of the present invention to provide a unique composition of matter embodied by low-calorie and low-fat cookies. This reduction in caloric and fat content answers an unmet need within the food industry to provide the consuming public with a healthier, higher fiber alternative to traditional types of cookies that typically are inherently fattening. It is another object of the present invention to provide cookies that have been fortified with insoluble fiber and other functional foods.

Dietary fiber gels for calorie reduced foods hold the key to meeting this need. Dietary fiber gels for calorie reduced foods are fully described in U.S. Pat. No. 5,766,662 (the '662 patent). These dietary fiber gels comprise insoluble dietary fibers consisting of morphologically disintegrated cellular structures, and are characterized by their ability to retain large amounts of water. Additionally, these dietary fiber gels are characterized by their high viscosity at low solid levels. Other insoluble fibers derived from cereals, grains and legumes consist of morphologically in tact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations.

More specifically, the present invention utilizes emulsified mixtures of the dietary fiber gels disclosed in the '662 patent, the emulsified mixtures further comprising, at a minimum, water and lipid. These emulsified mixtures are fully described in and are the subject of U.S. patent application Ser. No. 10/669,731 filed Sep. 24, 2003. These emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of cookies, further health benefits can be achieved by replacing a portion of fat with emulsified liquid shortening compositions comprising dietary fiber gel, water and lipid.

According to the present invention, fat and caloric content can be reduced by the replacement of the fat normally found in cookies with emulsified liquid shortening compositions comprising dietary fiber gel, water and lipid. This replacement of fat does not adversely affect either the taste or texture of the cookies. The result is that fat and caloric content of cookies can be manipulated with minimal effect on taste and texture, and as stated above, additional health benefits can be achieved through consumption of cookies comprising emulsified liquid shortening compositions comprising dietary fiber gel, water and lipid when functional foods are included in the formulations.

Further objects, advantages and features of the present invention will present themselves in the following detailed description.

### DETAILED DESCRIPTION OF THE PREFERRED EMBODIMENT

This invention is directed to cookies comprising emulsified liquid shortening compositions comprising dietary fiber gel, water and lipid. According to the present invention, fat and caloric content can be reduced by the replacement of fat normally found in cookies with emulsified liquid shortening compositions comprising dietary fiber gel, water and lipid (hereinafter “emulsified liquid shortening”). This replacement of fat does not adversely affect either the taste or texture of the cookies. The result is that fat and caloric content of cookies can be manipulated with minimal effect on taste and texture.

Alternatively, the cookies can be provided in the form of cookie dough with the intention that a consumer can bake them at a convenient, post-purchase time, and cookie dough is considered to be within the scope of this invention. As such, for purposes of this document, the term “cookies” is defined to include cookie dough.

According to the present invention, cookies can be formulated such that the cookies comprise 0.25 percent to 7.0 percent dietary fiber gel solids by replacing an appropriate amount, that is, prorated to deliver this range of dietary fiber gel solids, of fat, including oil and liquid shortening, with an essentially identical amount of emulsified liquid shortening. The result is that fat and caloric content of cookies can be manipulated with minimal effect on taste and texture, and as stated above, additional health benefits can be achieved through consumption of cookies comprising emulsified liquid shortening compositions comprising dietary fiber gel, water and lipid when functional foods are included in the formulations.

1. cookies, the cookies having a formulation, the cookies comprising emulsified liquid shortening composition comprising dietary fiber gel, water and lipid,
wherein the emulsified liquid shortening composition comprising dietary fiber gel, water and lipid is added in a prorated amount such that solids delivered by the dietary fiber gel represent 0.25 percent to 7.0 percent by weight of the overall cookie formulation, and
the emulsified liquid shortening composition comprising dietary fiber gel, water and lipid replaces an equal amount of fat used in an otherwise identical recipe of cookie that uses no emulsified liquid shortening compositions comprising dietary fiber gel, water and lipid, and
wherein the dietary fiber gel comprises insoluble dietary fiber.

2. cookie dough, the cookie dough having a formulation, the cookie dough comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.25 percent to 7.0 percent by weight of the overall cookie dough formulation, and
the emulsified liquid shortening composition comprising dietary fiber gel, water and lipid replaces an equal amount of fat used in an otherwise identical recipe of cookie dough that uses no emulsified liquid shortening compositions comprising dietary fiber gel, water and lipid and
wherein the dietary fiber gel comprises insoluble dietary fiber.
